(19) United States
(12) Patent Application Publication
(10) Pub. No.: US 2003/0231986 A1
(43) Pub. Date: Dec. 18, 2003

(54) Micro-array identification means

(75) Inventor: Thomas E. Kocher, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/174,190

(22) Filed: Jun. 18, 2002

(51) Int. Cl. B01L 3/00

(52) U.S. Cl. 422/99; 422/102; 422/104

(57) ABSTRACT

Micro-array receiver apparatus comprising: a micro-array receiver including a substrate and at least a first set of sites of a first biological probe which is adapted to interact with a first biological target sample, the first set of sites formed on the substrate; and an identifier associated with the micro-array receiver for identifying the at least first biological probe.

### FIELD OF THE INVENTION

This invention relates in general to molecular biological systems and more particularly to a means by which micro-array receivers can be identified.

### BACKGROUND OF THE INVENTION

There is a need to identify micro-array receivers or substrates of molecular biological reagents and samples so that both automated machines as well as humans can identify the micro-array receiver. As is well known (and described for example in U.S. Pat. No. 5,807,522 to Brown et al., issued Sep. 15, 1998, and in “DNA Microarrays: A Practical Approach”, Schena, Mark, New York, Oxford University Press, 1999, ISBN 0-19-963776-8), micro-arrays are arrays of very small samples of purified DNA or protein probe material arranged as a grid of hundreds or thousands of small spots on a substrate. When the micro-array is exposed to unknown target material, the target material selectively binds to the probe spots only where complementary bonding sites occur, through a process called hybridization. Subsequent quantitative scanning in a fluorescent micro-array scanner may be used to produce a pixel map of fluorescent intensities (See e.g., U.S. Pat. No. 5,895,915, DeWeerd et al., issued Apr. 20, 1999). This fluorescent intensity map can then be analyzed by special purpose algorithms that reveal the relative concentrations of the fluorescent targets and hence the level of gene expression, protein concentration, etc., present in the cells from which the target samples were extracted. In laboratory practice, a micro-array exposed to a sample target material, scanned and mapped via bio-informatic specific algorithms can be repeated many times with different arrays containing different probe materials and for different samples.

The present invention provides improved system productivity for the production of arrays of molecules on rigid, semi-rigid or flexible supports. Historically, arrays could be constructed either manually or mechanically through the use of photolithographic, robotically controlled or other apparatus for the precise metering and placement of molecules. Alternatively, arrays could be constructed through direct chemical synthesis on a solid support. Such devices and methods have the undesirable result that micro-arrays with a great number of individual molecular biological reagents are contained with little or no means to identify them uniquely, either by human observations or machine. The present invention addresses the drawbacks of previous systems and methods, by providing a means for the identification of arrays of molecules on rigid, semi-rigid or flexible supports.

Many examples exist for dispensing liquids in small volumes in the range of milliliters to sub-fractions of milliliters. For example, Pastinen et al. (Genorne Research, 7, 606-614 (1997)) create an array of oligonucleotides by manually applying 0.5˜IL of a solution of 5′-amino-modified oligonucleotides onto an epoxide-activated glass slide to produce a 3×3 array of oligonucleotides on a 0.36 cm˜ area of a preprinted glass slide.

Other, more traditional printing methods have been used to create patterns of a few different reagents on a solid support. Means such as silk screening, offset printing, and rotogravure printing have been used in the production of reagent test strips. In such methods, each reagent ink in applied separately. Johnson for example, U.S. Pat. No. 4,216,245, issued Aug. 5, 1980, discusses methods for the production of reagent test strip devices.

Pipette dispensing of reagents can be automated. Automation potentially increases the speed and accuracy of array production, while decreasing the necessary spacing between array positions. However, the utility of automated pipetting methods are severely limited in the number of different reagents that may be simultaneously applied (low parallelism). Cozzette et al., for example, U.S. Pat. No. 5,554,339, issued Sep. 10, 1996, discusses the use of micro-syringes for dispensing reagents during the production of bio-sensor devices.

High-speed robotics have also been used to print micro-arrays of amino-modified cDNA molecules onto silylated glass microscope slides (CEL Associates, Houston) or poly-l-lysine coated microscope slides (Schena, Bioassays 18:427-431 (1996); Schena et al., Proc. National. Academy Science, USA, 93:10614-10619 (1996).

Another approach to array printing is an adaptation of ink-jetting technology. For example, Hayes et al., U.S. Pat. No. 4,877,745, issued Oct. 31, 1989, discusses an ink-jet type method and apparatus for dispensing reagents, particularly in the production of reagent test strips.

Pin transfer is one approach that allows the simultaneous transfer of greater numbers of samples than possible with the above approaches.

Pirrung et al., U.S. Pat. No. 5,143,854, issued Sep. 1, 1992, Fodor et al., U.S. Pat. No. 5,510,270, issued Apr. 23, 1996, Fodor et al., U.S. Pat. No. 5,445,934, issued Aug. 29, 1995, and Chee et al., WO95/11995, issued May 4, 1995, discusses the production of high 2 density oligonucleotide arrays through photolithographic synthesi's of thd'oligonucle-otides, directly onto derivatized glass substrate.

McGall et al., U.S. Pat. No. 5,412,087, issued May 2, 1995, discusses a method for the production of a high density oligonucleotide array from pre-synthesized oligonucleotides.

Birch et al., U.S. Pat. No. 6,051,190, issued Apr. 18, 2000, and U.S. Pat. No. 6,303,387, issued Oct. 16, 2001, discusses a transfer rod for distribution of small amounts of liquid in biological or chemical analysis.

Bryning et al., U.S. Pat. No. 6,296,702 B1, issued Oct. 2, 2001, discusses an oscillating fiber apparatus for dispensing small volumes of a selected liquid onto a substrate.

Kowallis, U.S. Pat. No. 6,245,297 B1, issued Jun. 12, 2001, discusses an apparatus with a transport pathway for the production of micro-arrays having a great number of closely spaced spots.

In view of the above, the need is apparent for an efficient means for identifying the molecular biological reagents and samples that are contained on solid or semi-solid supports as well as any applications of additional materials or modifications to the micro-array through use in a laboratory environment. Preferably, the means should be relatively easy to implement, robust, and provide both a machine as well as a human identifiable piece and readily applicable to the production of micro-arrays having a great number of individual spots. Additionally, the means should be able to modify or update the information content contained in the identifying means thereby providing a method by which every step can be tracked through the processes of array manufacturing, sample application, and finally scanning/readout.

### SUMMARY OF THE INVENTION

According to the present invention, there is provided a solution to the problems and fulfillment of the needs discussed above.

According to a feature of the present invention, there is provided a micro-array receiver apparatus comprising: a micro-array receiver including a substrate and at least a first set of sites of a first biological probe which is adapted to interact with a first biological target sample, said first set of sites formed on said substrate, and

an identifier associated with said micro-array receiver for identifying said at least first biological probe.

Advantageous Effect of the Invention

The Invention has the Following Advantages

1. A micro-array receiver is provided having an identifier for identifying the biological probe(s) formed on said receiver.

2. The identifier is relatively easy to implement, is robust, and provides an identifier which can be both human and machine readable.

3. The identifier can be a type (magnetic, RFID) which is modifiable so that information can be modified, added or deleted.

### BRIEF DESCRIPTION OF THE DRAWINGS

FIG. 1 is a diagrammatic view of an embodiment of the present invention.

FIG. 2 is a diagrammatic view of another embodiment of the present invention.

FIG. 3 is a block diagram of a workflow which can be used with the present invention.

FIG. 4 is a diagrammatic view of details of an exemplary micro-array receiver which can be used in the present invention.

### DETAILED DESCRIPTION OF THE INVENTION

In general, the present invention relates to micro-array receiver apparatus having a micro-array receiver including a substrate and at least a first biological probe which is adapted to interact with a first target sample. The sites are formed on the substrate. An identifier is associated with the micro-array receiver for identifying the first biological probe. Preferably the micro-array receiver includes a plurality of sets of sites each set of sites being of a different biological probe which is adapted to interact with a different biological target sample. The plurality of sets of sites are formed on the substrate and the identifier identifies each of the plurality of biological probes.

The identifier can also identify one or more of the following: the target biological samples which interact with the biological probe(s); information about the micro-array, how it was manufactured, and how it was used in its application; information that can be modified, updated during the manufacture, sample application/readout processes.

The identifier can be one or more of the following; human readable information; bar code; magnetic or optical strip; radio-frequency identification (RFID) tag; etc.

The biological target site(s) formed on the micro-array receiver substrate can be formed by one or more of the following techniques: photolithography; ink jet printing, silk screening, liquid dispensing.

Preferably the micro-array receiver includes a substrate coated with a composition comprising micro-spheres (beads) dispersed in a fluid containing a gelling agent or a precursor to a gelling agent, wherein the micro-spheres are immobilized in a random or ordered position on the substrate. The substrate is free of receptors designed to physically or chemically interact with the micro-spheres. One or more sub-populations of the population of micro-spheres contain a unique optical bar code generated from at least one colorant associated with the micro-spheres and including a unique biological functionality or probe which reacts with analytes with which they come in contact.

The distribution or pattern of micro-spheres on the substrate may be entirely random (a spatial distribution showing no reference or bias) or be attracted or held to sites that are pre-marked or predetermined on the substrate. Each micro-sphere in the array has a distinct signature based on color which may be derived from mixing three dyes representing the primary colors Red (R), Green (G), and Blue (B) to create thousands of distinguishable micro-spheres with distinct color addresses (unique RGB values, e.g., R=0, G=204, B=153). The micro-spheres are made with active sites on their surface to which are attached a specific bioactive probe. Therefore, each color address can correspond to a specific bioactive probe.

A micro-array or population of micro-spheres can include a few or hundreds or more of sub-populations of micro-spheres, where each sub-population comprises the same color code and the same bio-active probe. Each micro-array of micro-spheres occupies a sub-area of the substrate and is repeated in a pattern over the area of the substrate. The dimensional area of the micro-array sub-area may be comparable to the dimensional area of a microtiter well or multiple wells may overlay a micro-array sub-area.

The micro-spheres are preferably coated onto the substrate as disclosed in U.S. patent application Ser. No. 09/942,241, chari et al.

In order to use a micro-array having bioactive probes to analyze an unknown biological target sample, the sample to be analyzed has to be non-selectively labeled by using fluorescent dyes or chemiluminescent active molecules.

A biological target sample is placed into contact with the micro-array bioactive probes. The fluorescently/chemiluminescently signals which result from the hybridization of the unknown biological target sample with bioactive probes on the surface of the coated micro-spheres are detected and analyzed by an electronic camera/image processor system.

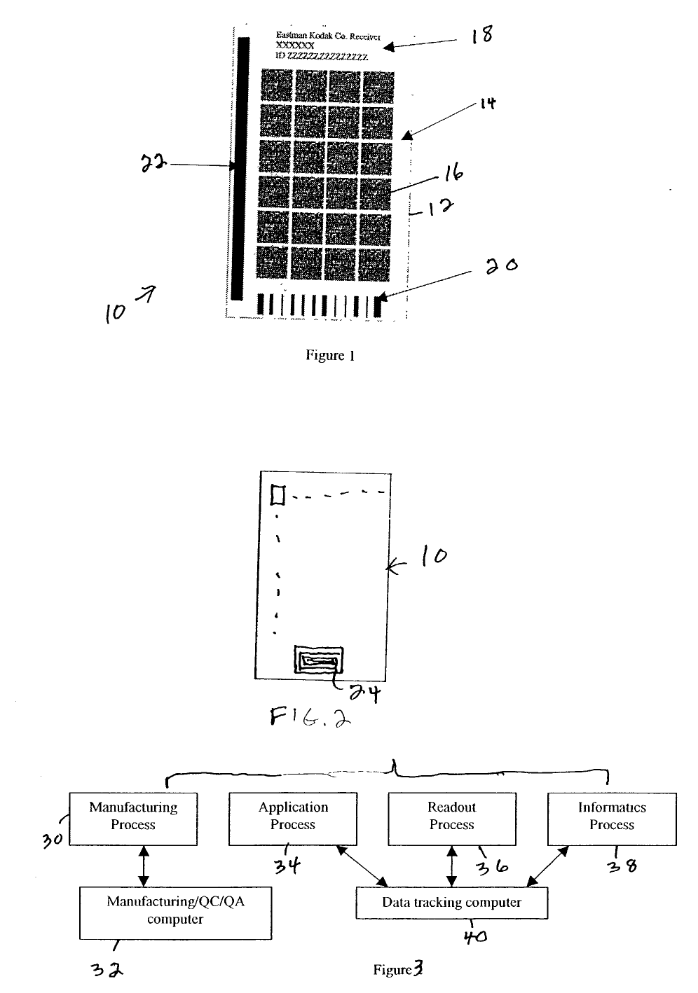

Referring to FIG. 1, there is shown micro-array receiver apparatus 10 according to the present invention. Apparatus 10 includes a micro-array receiver 12 including a substrate 14 having formed thereon a pattern of twenty-four regions 16 in a matrix of four rows and six columns (as viewed by rotating FIG. 1 by 90°). Each region includes an identical micro-array of a plurality of biological probe sites. Each different biological probe is adapted to interact with a specific biological target sample.

Micro-array receiver apparatus 10 includes several identifiers 18, 20 and 22 for storing or presenting information relative to the micro-array receiver and its biological probes. Identifier 18 is human readable including letters, numbers and other visually identifiable symbols. Identifier 20 is a machine readable bar code. Identifier 22 is a magnetic strip that stores information that can be updated (dynamically) to reflect the state of manufacturing and how it was used. Human readable identifier 18 can identify the specific biological activity associated with the receiver. It could also identify that a receiver is one of a number of receivers in a specific series (e.g., “3 of 10”). Bar code identifier 20 can be read by the manufacturing computers as well as by a data tracking computer of the end user.

FIG. 2 shows apparatus 10 with an RFID identifier 24 which can be written to and read from using well known RFID technology.

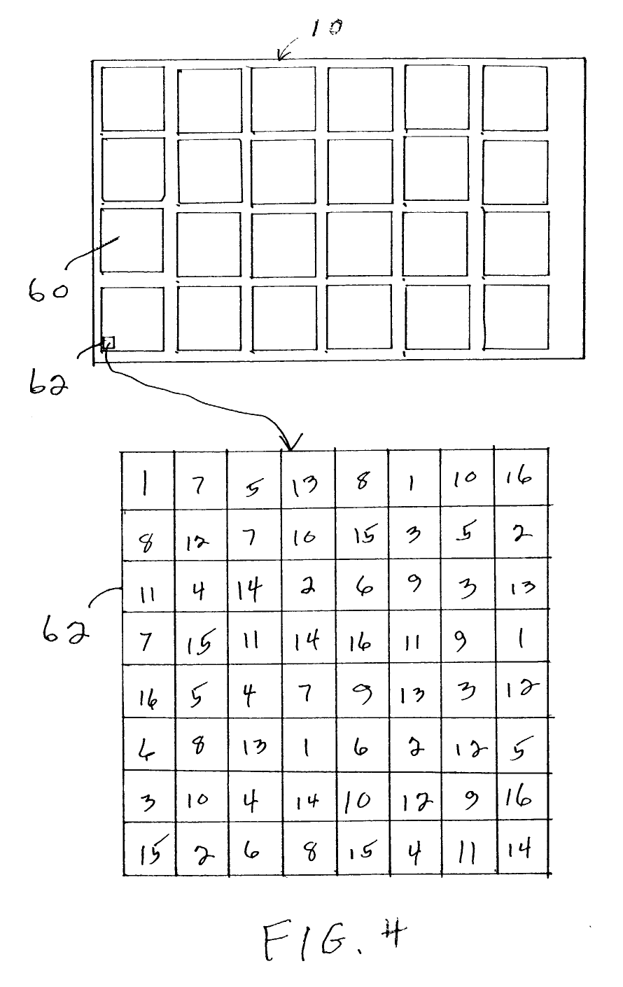

FIG. 3 illustrates the functions of an identifier 22 which can be updated. Box 30 represents a manufacturing process that can be stored on magnetic strip 22 or RFID identifier 24 and which can be changed by a manufacturing/QC/QA computer 32. Boxes 34, 36, and 38 represent application process, readout process and informatics process that can be stored in a magentic or RFID identifier and which can be updated by data tracking computer 40.

FIG. 4 illustrates an example of micro-array receiver apparatus 10 including regions 60 having identical micro-array of randomly distributed biological probe sites, a portion 62 of which are shown in the exploded view. In this view, sixteen different biological probes attached to micro-spheres, are randomly distributed throughout portion 62 of region 60. Each probe is attached to a micro-sphere of a color unique to that probe, so that micro-spheres of sixteen different colors are present in portion 16. If, for example, a sample analyte containing each of the sixteen complementary targets to the sixteen probes is brought into contact with portion 16, the hybridization between the sixteen targets and sixteen probes would produce luminescence or fluorescence of sixteen different colors which can be detected by an appropriate detection system.

The invention has been described in detail with particular reference to certain preferred embodiments thereof, but it will be understood that variations and modifications can be effected within the spirit and scope of the invention.

### PARTS LIST

10 micro-array receiver apparatus

12 micro-array receiver

14 substrate

16 pattern of 24 regions

18 human readable identifier

20 machine readable bar code identifier

22 magnetic strip identifier

24 RFID identifier

30 manufacturing process

32 manufacturing/QC/QA computer

34,36,38 application processes

40 data tracking computer

60 region

62 region

What is claimed is:

1. Micro-array receiver apparatus comprising:
a micro-array receiver including a substrate and at least a first set of sites of a first biological probe which is adapted to interact with a first biological target sample, said first set of sites formed on said substrate; and
an identifier associated with said micro-array receiver for identifying said at least first biological probe.

2. The micro-array receiver apparatus of claim 1 wherein said identifier is one or more of a bar code, a human readable identifier, a magnetic region, a radio frequency identifier.

3. The micro-array receiver apparatus of claim 1 wherein said micro-array receiver includes a plurality of sets of sites, each set of sites being of a different biological probe which is adapted to interact with a different biological target sample, said plurality of sets of sites formed on said substrate; and
wherein said identifier identifies each of said plurality of biological probes.

4. The micro-array apparatus of claim 1 wherein said first set of sites are formed on said substrate by at least one of the following:
photolithography, ink jet printing, silk screening, liquid dispensing.

5. The micro-array apparatus of claim 1 wherein said set of sites are formed on said substrate by coating said substrate with a composition including a set of biological probe modified micro-spheres immobilized in a coating containing a gelling agent or a precursor to a gelling agent, said set of micro-spheres containing an optical bar code generated from at least one colorant associated with said biological probe, wherein said biological probe is adapted to interact fluorescently/chemiluminescently with fluorescently/chemiluminescently labeled biological target sample.

6. The apparatus of claim 1 wherein said identifier includes one or more of the following information: how the micro-array was manufactured, what specific materials it contains, how the micro-array can be read, application specific information, patient, technician or user information.

7. The apparatus of claim 1 wherein said at least first set of sites are formed on a region of said substrate and wherein said identifier is located on said substrate outside of said region.

8. The apparatus of claim 1 wherein said identifier is located on one of the front or back of said substrate.
